(19) United States
(12) Patent Application Publication
(10) Pub. No.: US 2025/0200272 A1
(43) Pub. Date: Jun. 19, 2025

(54) CONTROL METHOD FOR INFORMATION PROCESSING APPARATUS, INFORMATION PROCESSING APPARATUS, AND STORAGE MEDIUM

(71) Applicant: CANON KABUSHIKI KAISHA, Tokyo (JP)

(72) Inventor: TAKAYA UEDA, Kanagawa (JP)

(21) Appl. No.: 18/974,341

(22) Filed: Dec. 9, 2024

(30) Foreign Application Priority Data
Dec. 15, 2023 (JP) 2023-211949

(51) Int. Cl. G06F 40/166

(52) U.S. Cl. CPC G06F 40/166

(57) ABSTRACT

An information processing apparatus includes at least one memory that stores instructions, and at least one processor that, upon execution of the stored instructions, is configured to calculate, based on a size attribute of a designated text region, a number of characters displayable in the text region, generate a prompt including an instruction to perform processing on text, text that was input into the text region and the calculated number of characters, and cause a learning model to generate processed text by performing the instruction included in the generated prompt on the text included in the generated prompt in accordance with the calculated number included in the generated prompt, wherein the text input into the text region is updated with the generated processed text.

### BACKGROUND

### Field

The present disclosure relates to a control method of an information processing apparatus, an information processing apparatus, and a storage medium.

### Description of the Related Art

As an example of a method of performing editing of layout data including a layout of a poster or a flyer, for example, there is a method using a template material. In this case, for example, after a template material close to a completed image is selected, content such as text and an image is added to or deleted from the template material, and the position and the size of each piece of content are changed, thereby the entire layout is adjusted. In a case where text content exists, one or more text regions into which texts are input are prepared in a template, and the texts are input into the text regions.

In recent years, it has become possible to use what is called a language generation artificial intelligence (AI) technique when text content is input during the above-described editing of layout data. Examples of such a language generation AI technique include ChatGPT® and Bard®.

During the editing of layout data, in order to adjust the layout after text is input, the size of a text region is sometimes changed. At this time, a deign issue, such as generation of an excess blank space due to an expansion in the size of a text region and protrusion of text from the text region due to a reduction in the size of the text region, sometimes occurs.

A similar issue can arise also in a case where the number of characters of text displayable in a text region is changed due to a change in a font size, line spacing, or the like.

As a measure to cope with such an issue, Japanese Patent Application Laid-Open No. H9-231207 discusses a technique of adjusting a font size in accordance with the size of a region. Nevertheless, in this case, the consistency with a surrounding design may be lost due to the font size becoming too small, or the font size becoming too large.

Japanese Patent Application Laid-Open No. 2013-109408 discusses a technique of adjusting the number of characters of text by preparing a word replacement dictionary, and replacing a word in the text with another word with a different number of characters. In this technique, the above-described processing of replacing a word in the text is repeatedly performed until the number of characters becomes the number of characters suitable for the size of a size-changed region. In this technique, since the number of characters of the text is adjusted, there is no need to change the font size, and it is possible to maintain the consistency with a surrounding design.

Nevertheless, in the technique discussed in Japanese Patent Application Laid-Open No. 2013-109408, since replacement is performed at a word level, in some cases, it is difficult to deal with a drastic change in the number of characters. In addition, since the word replacement is locally performed, when sentences are read as a series of sentences, it is anticipated that the sentences may contain unnatural content.

### SUMMARY

According to an aspect of the present disclosure, a control method performed by an information processing apparatus includes calculating, based on a size attribute of a designated text region, a number of characters displayable in the text region, generating a prompt including an instruction to perform processing on text, text that was input into the text region and the calculated number of characters, and causing a learning model to generate processed text by performing the instruction included in the generated prompt on the text included in the generated prompt in accordance with the calculated number included in the generated prompt, wherein the text input into the text region is updated with the generated processed text.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration of an information processing system.

FIG. 2 is a diagram illustrating an example of a hardware configuration of an image output apparatus.

FIG. 3 is a diagram illustrating an example of a hardware configuration of an information processing apparatus.

FIG. 4 is a diagram illustrating an example of a functional configuration of an information processing system.

FIG. 5 is a diagram illustrating an example of layout data.

FIG. 6 is a diagram illustrating an example of a layout data edit screen.

FIG. 7 is a diagram illustrating an overview of a language generation artificial intelligence (AI) technique.

FIG. 8 is a flowchart illustrating an example of processing performed by an information processing system.

FIG. 9 is a flowchart illustrating an example of processing performed by the information processing system.

FIG. 10 is a diagram illustrating an example of the layout data edit screen.

FIG. 11 is a diagram illustrating an example of the layout data edit screen.

FIG. 12 is a diagram illustrating an example of the layout data edit screen.

FIG. 13 is a diagram illustrating an example of the layout data edit screen.

FIG. 14 is a diagram illustrating an example of a user interface (UI) of an information processing system.

FIG. 15 is a diagram illustrating an example of a functional configuration of the information processing system.

FIG. 16 is a flowchart illustrating an example of processing performed by the information processing system.

FIG. 17 is a flowchart illustrating an example of processing performed by the information processing system.

### DESCRIPTION OF THE EMBODIMENTS

Hereinafter, an exemplary embodiment of the present disclosure will be described in detail with reference to the accompanying drawings.

In the specification and drawings, components having substantially the same functional configuration are assigned the same reference numeral, and the redundant description will be accordingly omitted.

### <Overview of Language Generative AI Technique>

First, in order to facilitate understanding of features of an information processing system according to an exemplary embodiment of the present disclosure, an overview of a language generation artificial intelligence (AI) such as ChatGPT® and Bard® will be described below.

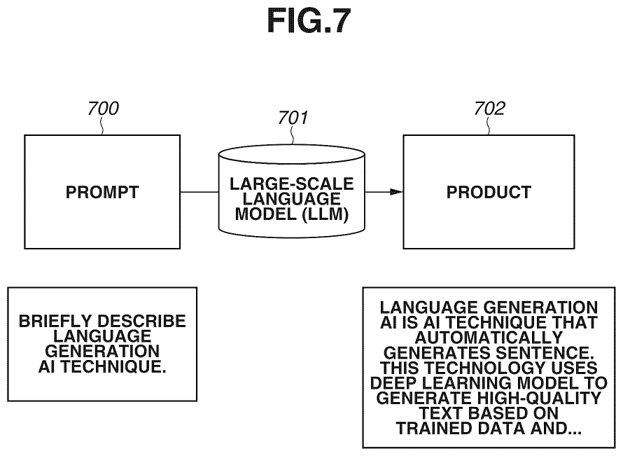

For example, FIG. 7 is a diagram illustrating an overview of a language generation AI technique. In the language generative AI technique, a large-scale language model (LLM) 701 that receives, as an input, a prompt 700 indicating an instruction related to text to be generated and which outputs a product 702 including text with a high probability of conforming to the prompt 700 is used. A relationship between an input value and “context” is acquired when the LLM 701 was created by performing learning using a large number of sentences. The LLM 701 can also change the product 702 to be generated by changing an initial value mainly generated from a random number in generating the product 702. In addition, by giving text and an appropriate instruction to the prompt 700, it becomes possible to apply various types of processing such as summarizing the text, improving content of the text, and translating the text.

An example of an information processing system according to a first exemplary embodiment of the present disclosure will be described below.

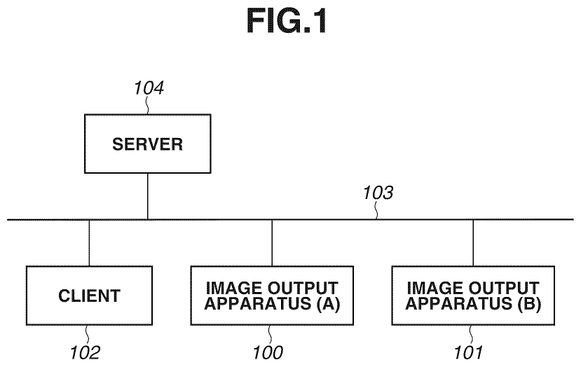

FIG. 1 is a diagram illustrating an example of a system configuration of the information processing system according to the present exemplary embodiment, and illustrates an example of a case where the information processing system is configured as a printing system that performs layout data editing for an image output apparatus. In the printing system illustrated in FIG. 1, in a client (for example, a terminal apparatus such as a personal computer (PC)) connected thereto from the outside, editing of layout data and transmission of a print job to the image output apparatus are performed. The image output apparatus corresponds to an apparatus that generates a print product by forming an image on a recording medium such a sheet, and outputs the print product. When a print job is created, an editing work of a print setting is sometimes performed on a screen of the above-described client, for example. Hereinafter, a system configuration of the printing system exemplified in FIG. 1 will be described in more detail.

As illustrated in FIG. 1, a client 102 is connected to a server 104, an image output apparatus 100, and an image output apparatus 101 via a network 103. The client 102 is used in an editing work of layout data, such as a poster and a flyer, for example, and requests the server 104 to perform part of editing and data processing related to the layout data and rendering processing. The server 104 schematically represents a server that performs various types of processing such as the editing and data processing and the rendering processing on various types of data such as layout data. The client 102 generates a print job by applying a print setting to the layout data obtained after the editing, and transmits the print job to a desired image output apparatus (for example, a designated image output apparatus of the image output apparatuses 100 and 101).

In the example illustrated in FIG. 1, a case where the number of image output apparatuses that can be accessed by the client 102 via the network 103 is two is illustrated. Nevertheless, the number of image output apparatuses is not limited, and may be one, or may be three or more. In a similar manner, the number of clients and the number of servers are both one in the example illustrated FIG. 1, but these may be each two or more.

As an example of processing related to printing, an example case where a print job is transmitted to the image output apparatus 100 via a printer driver from a printing application installed on the client 102 will be described. It is assumed that the above-described printing application and the above-described printer driver are previously installed on the client 102.

The printing application acquires device information on the associated image output apparatus 100 and printing parameters such as a sheet type, a sheet size, and print quality from the printer driver, and edits a print setting within a range of the acquired series of printing parameters. The printing application generates a print job based on the above-described print setting and an image of the layout data on which the rendering processing has been performed by the server 104, and transmits the print job to the image output apparatus 100 via spooling by the printer driver. The image output apparatus 100 performs printing based on the print setting of the print job received from the printing application.

The image output apparatus 100 holds configuration information regarding ink and sheets that are to be used and status information such as an idle state and a print error, as the device information. By displaying a warning message on a main body panel in a case where printing cannot be normally performed due to a factor such as an abnormality of a state such as a sheet remaining amount shortage and ink out, and a print setting error, the image output apparatus 100 may present the reason why printing cannot be normally performed, to a user.

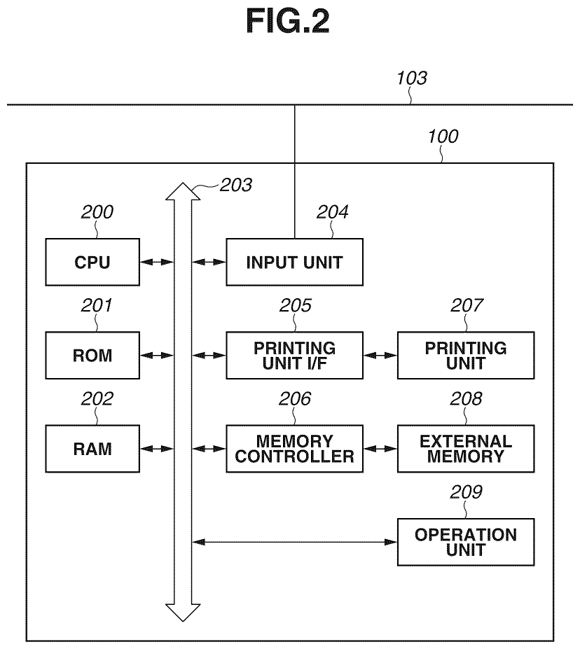

An example of a hardware configuration of the image output apparatus 100 will be described with reference to FIG. 2. Because the image output apparatus 101 can be implemented by a configuration substantially identical to that of the image output apparatus 100, the detailed description thereof will be omitted.

An operation of the image output apparatus 100 is controlled by a central processing unit (CPU) 200. The CPU 200 operates based on a control program stored in a region for programs in a read only memory (ROM) 201, and a control program stored in a storage region of an external memory 208. The CPU 200 outputs an image signal as output information to a printing unit (printer engine) 207 connected to a printing unit I/F 205 via a system bus 203. By performing communication with the client 102 via an input unit 204, the CPU 200 may notify the client 102 of information in the image output apparatus 100 through the communication. The CPU 200 can also receive output data to be output to the printing unit 207, via the input unit 204.

A random access memory (RAM) 202 is a temporary storage region functioning as a main memory or a work area of the CPU 200. The RAM 202 may have a configuration in which a memory capacity thereof can be expanded by using an optional RAM connected to a memory expansion port (not illustrated). The RAM 202 is used as an output information loading region, an environmental data storage region, or a nonvolatile memory, for example.

The external memory 208 is implemented by a hard disk drive (HDD), an integrated circuit (IC) card, or the like, and access thereto is controlled by a memory controller 206. The external memory 208 can be connected as an optional memory, and can store font data, emulation programs, form data, information regarding used ink, information regarding the type and the size of a fed sheet, and main body status information.

An operation unit 209 includes a panel implemented by a display device such as a liquid crystal display, and is configured to be able to display various types of information on the panel.

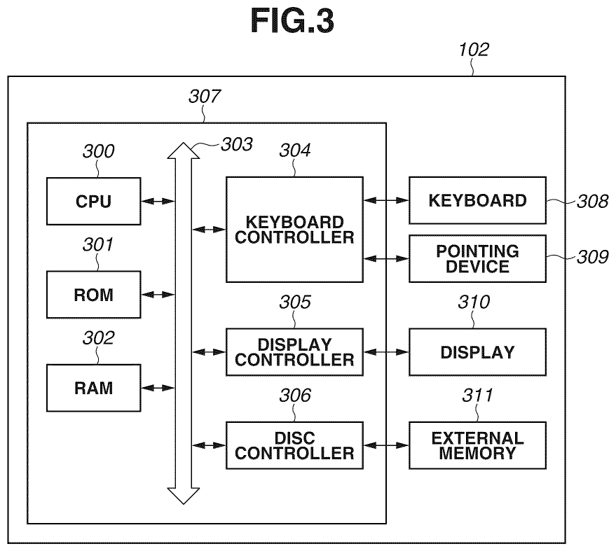

An example of a hardware configuration of an information processing apparatus applicable as the client 102 illustrated in FIG. 1 will be described with reference to FIG. 3. Because the server 104 can be implemented by using a configuration substantially identical to that of the client 102, the detailed description thereof will be omitted.

In a main body 307 of a computer, a CPU 300, a ROM 301, a RAM 302, a keyboard controller 304, a display controller 305, and a disc controller 306 are included.

The CPU 300 reads various programs such as a control program, a system program, and an application program from an external memory 311 via the disc controller 306 and loads the programs into the RAM 302. By executing the various programs loaded into the RAM 302, the CPU 300 performs various types of data processing and display control of a display 310. The CPU 300 may read the control program and the like from the ROM 301. In addition, the CPU 300 may be implemented as a dedicated circuit such as an application specific integrated circuit (ASIC). The CPU 300 and the dedicated circuit correspond to examples of a hardware processor and a hardware circuit.

The disc controller 306 controls access to the external memory 311 such as an HDD, a compact disk (CD)-ROM, a digital versatile disc (DVD)-ROM, and a universal serial bus (USB).

The RAM 302 may have a configuration in which a capacity thereof can be expanded by using an optional RAM (not illustrated), and is mainly used as a work area of the CPU 300.

The keyboard controller 304 controls key input from an input device such a keyboard 308 and a pointing device 309.

The display controller 305 controls display on the display 310.

In each exemplary embodiment of the present disclosure, unless otherwise stated, the CPU 300 controls each component connected to a main bus 303, via the main bus 303. As a matter of course, in the server 104, a configuration that is not essential, such as the display 310, may not be included.

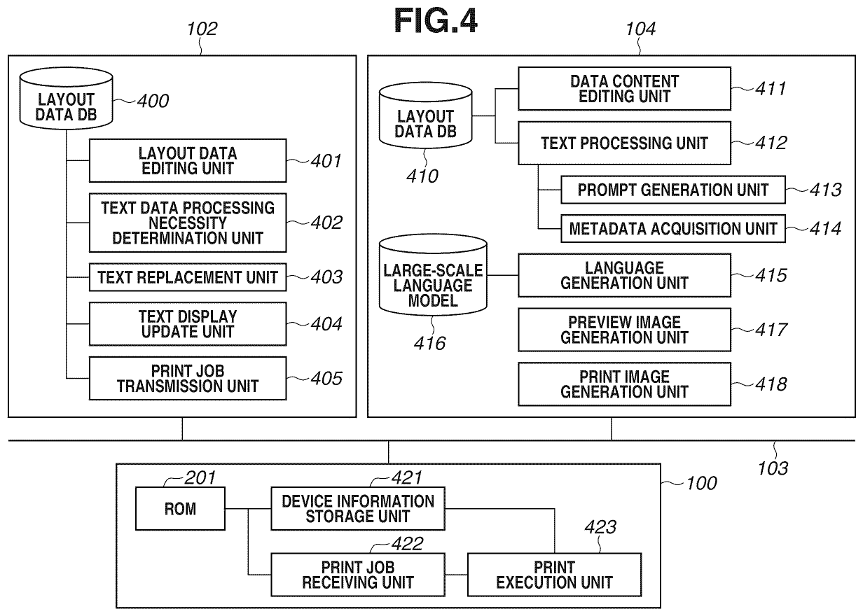

An example of a functional configuration of the information processing system according to the present exemplary embodiment will be described with reference to FIG. 4, in particular, with a focus on the configurations of the image output apparatus 100, the client 102, and the server 104 that have been described with reference to FIGS. 1 to 3. Because the image output apparatus 101 is substantially identical to the image output apparatus 100, a detailed description thereof will be omitted.

First, an example of a functional configuration of each of the client 102 and the server 104 will be described.

A layout data editing unit 401 adds and deletes content such as a character and an image to be placed on a print product such as a poster and a flyer, and performs an adjustment of a layout of each piece of content. In the case of applying processing such as clipping and filling to each piece of content, a request for the processing is issued from the layout data editing unit 401 to a data content editing unit 411 of the server 104. Layout data is stored in a layout data database (DB) 400 of the client 102 as a cache, or stored in a layout data DB 410 of the server 104 for each client 102 (or for each account in a case where a user account exists).

A text data processing necessity determination unit 402 determines whether processing of text in a text region in the layout data needs to be performed.

In a case where it is determined that processing of text is necessary, a text replacement unit 403 performs the processing on the target text and replacement of an original text to be processed with a processed text.

In a case where the text replacement is performed, a text display update unit 404 performs an update of display of the target text.

Details of the processing performed by the text data processing necessity determination unit 402, the text replacement unit 403, and the text display update unit 404 will be separately described below together with a description of a series of processes performed by the information processing system.

A print job transmission unit 405 creates a print job and transmits the created print job to the image output apparatus 100. When a print job is created, a request for layout data preview or printing image generation processing is issued from the print job transmission unit 405 to a preview image generation unit 417 or a printing image generation unit 418 of the server 104.

In response to an instruction from the text replacement unit 403, a text processing unit 412 of the server 104 issues a text generation request to a language generation unit 415. At this time, prompt information to be used in text generation is generated by a prompt generation unit 413, and the text processing unit 412 uses the prompt information for the text generation request. In generating the prompt information, the prompt generation unit 413 may use metadata regarding a target text acquired by a metadata acquisition unit 414.

Based on the prompt information generated by the prompt generation unit 413, the language generation unit 415 generates text using a large-scale language model 416. The generated text is transmitted by the text processing unit 412 to the client 102.

Next, an example of a functional configuration of the image output apparatus 100 will be described.

The image output apparatus 100 holds a device information storage unit 421, a print job receiving unit 422, and a print execution unit 423.

The print job receiving unit 422 receives a print job transmitted from the client 102.

The print execution unit 423 performs print processing based on the above-described received print job.

The device information storage unit 421 holds information regarding the type and a remaining amount of ink mounted on the image output apparatus 100, information regarding the type and the size of a registered sheet or a fed sheet, main body status information of the image output apparatus 100, and status information of a print job. In a case where an image output apparatus 100 to be used is predetermined, in order to create layout data suitable for the image output apparatus 100, information held in the device information storage unit 421 may be used.

In this case, target information may be acquired from the device information storage unit 421 and may be stored in the client 102 or the server 104 in association with the layout data DB 400 or 410.

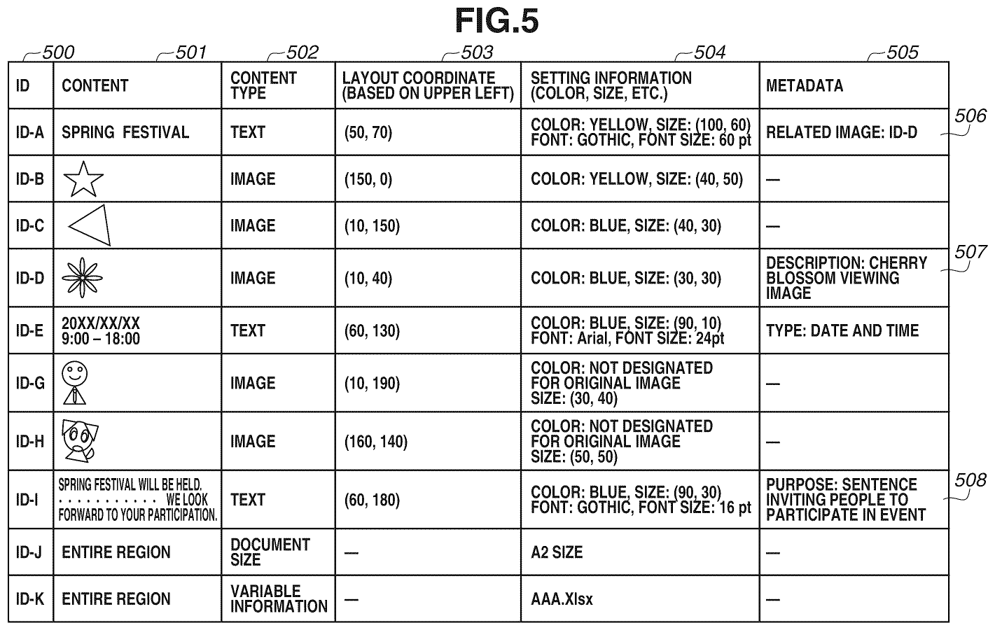

An example of layout data stored in the layout data DBs 400 and 410 will be described with reference to FIG. 5. A data table illustrated in FIG. 5 is stored for each piece of layout data, for example. In the data table illustrated in FIG. 5, regions of an identification (ID) 500, content 501, a content type 502, a layout coordinate 503, setting information 504, and metadata 505 are provided. For each piece of content, information regarding the content can be set in each region.

In the region of the ID 500, identification information for uniquely identifying each piece of content on the layout data is set.

In the region of the content 501, a value of each piece of content such as a character and an image laid out on the layout data is set.

In the region of the content type 502, information indicating the type of content set in the region of the content 501 is set.

In the region of the layout coordinate 503, values indicating the position of each piece of content on the layout data is set.

In the region of the setting information 504, attribute values indicating features of each piece of content such as the color and the size of the content is set.

In the present exemplary embodiment, in a case where the content type 502 is text, coordinates and a size of a text region prepared for the text are indicated. In a case where target content is the text, an attribute value unique to text, such as a font type, a font size, and line spacing, may be held as the setting information 504.

In the region of the metadata 505, metadata of each piece of content can be held. In the present exemplary embodiment, in the case where the content type 502 is text, a type and a purpose of the text to be described may be set as the metadata. For example, in an example illustrated as a sample 508, information indicating the purpose of a target text is set in the region of the metadata 505. In an example illustrated as a sample 506, identification information of an image related to a target text is set in the region of the metadata 505.

In a case where the content type 502 is an image, a description of the image may be set in the region of the metadata 505. For example, in an example illustrated as a sample 507, a description “description: cherry blossom viewing image” is set for the target image in the region of the metadata 505.

As illustrated in FIG. 5, no metadata is set for some pieces of content.

A setting regarding the entire layout data, such as a document size and data for variable printing, may be held. In this case, for example, it is sufficient that “entire region” is held as a value in the region of the content 501, a setting type is held in the region of the content type 502, and a setting value is held in the region of the setting information 504.

As a matter of course, the above-described example is a mere example. For example, operation of the layout data may be such that a separate file is used for each type of parameter, or the layout data may include a parameter of another type other than the types exemplified above.

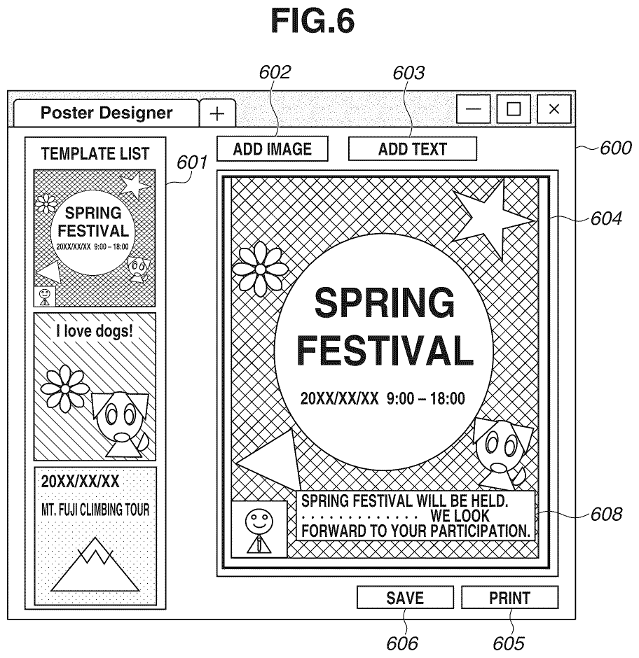

An example of a layout data edit screen 600 for the image output apparatus 100 that is to be displayed on the display 310 of the client 102 will be described with reference to FIG. 6. The layout data edit screen 600 includes a template list 601 as a region in which layout template candidates are displayed in list form. Via the template list 601, the user can browse and select a template closest to a completed form of the layout data. The template selected via the template list 601 is displayed in a layout editing area 604. Information regarding templates displayed in the template list 601 may be acquired as layout data from the layout data DB 400 or 410, for example, or may be acquired from an external network service such as a cloud service and a social networking service (SNS).

The layout data editing unit 401 or the data content editing unit 411 performs editing such as position adjustment, color compensation, clipping, or filling on each piece of content displayed in the layout editing area 604.

In the case where the target content is the text, based on an instruction received via the keyboard 308, for example, reception of input of a target text and editing of a designated text are performed. In one specific example, by using the keyboard 308, the user can input a desired text into a text region 608.

Addition of content such as an image and text to the layout editing area 604 is performed based on an instruction issued via an image addition button 602 or a text addition button 603. In one specific example, in a case where the image addition button 602 or the text addition button 603 is pressed, a file dialog may be displayed, and content may be taken in by a file corresponding to a designated path being imported via the file dialog. As a matter of course, the content is not limited to texts and images, and content of another type may be selectable as a target content, and in such a case, a button for receiving an instruction to add the content may be displayed. In addition, an import source of content is not specifically limited, and target content may be acquired from an external network service such as a cloud service and an SNS. In another example, in a case where a drag-and-drop operation of content in the layout editing area 604 is received, the content may be taken in.

An instruction to perform printing is received via a printing execution button 605, for example. If the printing execution button 605 is pressed, the print job transmission unit 405 creates a print job of the layout data displayed in the layout editing area 604, and transmits the print job to a designated image output apparatus (for example, the image output apparatus 100 or 101).

An instruction to save the layout data being edited may be received via a save button 606. In a case where the save button 606 is pressed, the layout data being edited may be saved in a predetermined storage region (for example, the layout data DB 400 or 410).

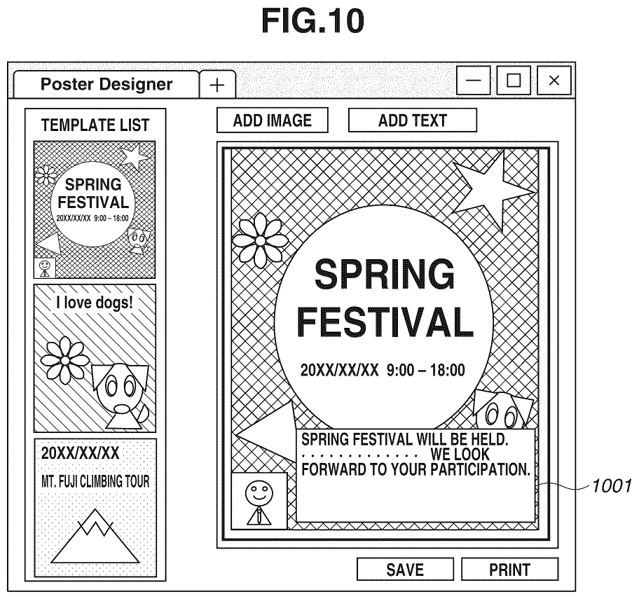

As described above, the information processing system according to the present exemplary embodiment is configured such that the position and the size of each piece of content in the layout editing area 604 can be adjusted. For example, FIG. 10 is a diagram illustrating an example of the layout data edit screen 600. In the example illustrated in FIG. 10, a text region 1001 is displayed, and the size of the text region 1001 can be expanded and reduced. Expansion and reduction of the size of the text region 1001 is performed based on an instruction received via the pointing device 309, for example.

On one hand, by the expansion of the size of the text region 1001, the size of the text region 1001 becomes larger than a region occupied by an input text, and an excessive blank space is sometimes generated as exemplified in FIG. 10. On the other hand, by the reduction of the size of the text region 1001, the size of the text region 1001 becomes smaller than the region occupied by the input text, and the text sometimes fails to fit into the text region. In view of such a situation, the information processing system according to the present exemplary embodiment is provided with a function of performing processing on an input text in such a manner as to be fit the changed size of the text region 1001 in a case where the size of the text region is changed. Thus, hereinafter, the function of the information processing system according to the present exemplary embodiment will be described in more detail.

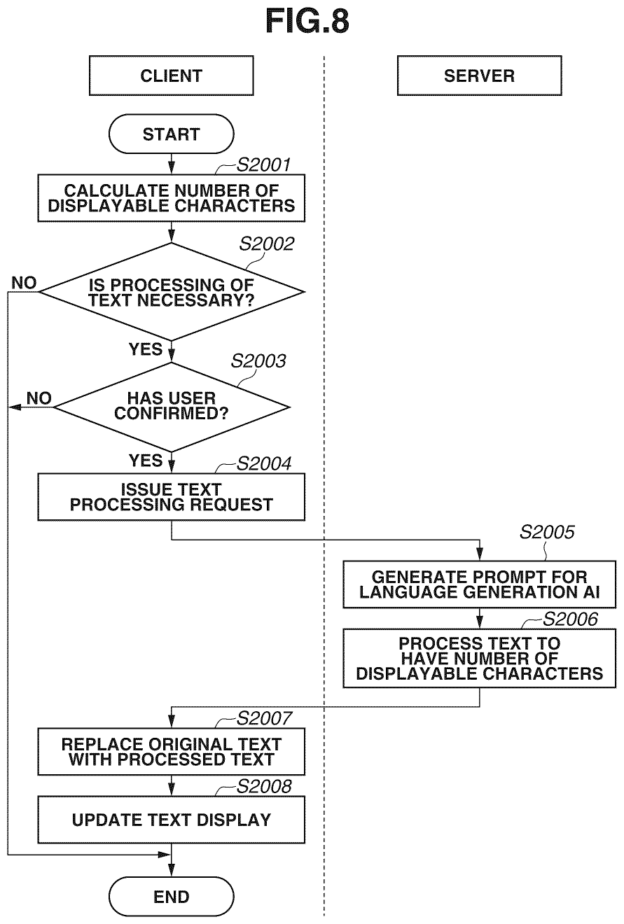

An example of processing performed by the information processing system according to the present exemplary embodiment will be described with reference to FIG. 8, in particular, with a focus on processing related to the processing of text input into a text region in a case where the size of the text region is changed on the layout data edit screen 600. A series of processes illustrated in FIG. 8 is implemented by the CPU 300 loading a program stored in the ROM 301 into the RAM 302 and executing the program, for example.

The series of processes illustrated in FIG. 8 is started by the text replacement unit 403 at a timing at which the printing execution button 605 on the layout data edit screen 600 is pressed in the client 102, or at a timing at which the save button 606 is pressed, for example. Nevertheless, the above-described timing is a mere example, and a trigger for a start of the series of processes illustrated in FIG. 8 is not limited to processing related to printing or saving of the content. In one specific example, the series of processes illustrated in FIG. 8 may be started at a timing that is a breakpoint in an editing work of target content. Alternatively, in another example, the series of processes illustrated in FIG. 8 may be started at a timing at which a change in the size of a target text region is detected.

In step S2001, the text data processing necessity determination unit 402 calculates the number of characters of text displayable in a target text region based on information such as the size of the text region, a character font type, a font size, and line spacing. A calculation method of the number of characters of text displayable in a target text region in this case is not specifically limited. For example, a method generally performed in a composition and the like can also be used.

In step S2002, the text data processing necessity determination unit 402 determines whether the processing of text displayed in a target text region needs to be performed based on a calculation result of the number of characters of the text displayable in the target text region that has been obtained in step S2001.

In a case where the text data processing necessity determination unit 402 determines in step S2002 that the processing of the target text is not necessary (NO in step S2002), the text data processing necessity determination unit 402 ends the series of processes illustrated in FIG. 8.

On the other hand, in a case where the text data processing necessity determination unit 402 determines in step S2002 that the processing of the target text is necessary (YES in step S2002), the text data processing necessity determination unit 402 advances the processing to step S2003. For example, in a case where the number of characters of an input text is excessively larger than the number of characters of text displayable in the text region, or in a case where the number of characters thereof is excessively smaller (for example, in a case where a difference exceeds a threshold value), the text data processing necessity determination unit 402 may determine that the processing of the text needs to be performed. In this manner, in a case where a difference between a preset threshold value and a difference between the number of characters of text displayable in a text region and the number of characters of the input text satisfies a predetermined condition, the text data processing necessity determination unit 402 may determine that the processing of the text needs to be performed.

For example, the example illustrated in FIG. 10 illustrates a state in which the size of the text region 608 has been expanded on the layout data edit screen 600 exemplified in FIG. 6. The text region 1001 illustrated in FIG. 10 corresponds to a result of expanding the size of the text region 608 illustrated in FIG. 6. By the expansion of the size thereof, the number of characters of text displayable in the text region 1001 has become excessively larger than the number of characters of an actually-input text (for example, a difference exceeds a threshold value), and a blank space is generated. For this reason, in this case, the text data processing necessity determination unit 402 determines that the processing of the text input into the text region 1001 needs to be performed.

The example of the case where the size of a text region is changed has been described above, but a situation where the difference between the number of characters of text displayable in a text region and the number of characters of an input text becomes excessively large (exceeds a threshold value) is not limited only to the above-described example. For example, a situation where the difference between the number of characters of a text displayable in the text region and the number of characters of an input text becomes excessively large by a font type, a font size, or line spacing of a text region being changed can be expected. In another example, a situation where the difference between the number of characters of a text displayable in the text region and the number of characters of the input text becomes excessively large by a change of increasing or decreasing the number of characters being performed on the text input into the text region can also be expected. Also in such a case, the text data processing necessity determination unit 402 may determine that the processing of a text displayed in a target text region needs to be performed.

In the present exemplary embodiment, for the sake of convenience, a size, a font type, a font size, and line spacing of a text region, and the number of characters of text will be sometimes collectively referred to as a size attribute of the text region. In other words, by a change in the size attribute of a target text region, a state in which the processing of text displayed in the text region needs to be performed can arise. The size, the font type, the font size, and the line spacing of each text region may be set or changed by the layout data editing unit 401.

Whether the processing of text displayed in a target text region needs to be performed can be determined depending on whether an absolute value of a difference between the number of characters of text displayable in the text region and the number of characters of text displayed in the text region exceeds a threshold value, for example. In this case, the text data processing necessity determination unit 402 is only required to determine that the processing of a target text needs to be performed in a case where the above-described absolute value of the difference between the numbers of characters exceeds the threshold value, and determine that the processing of the target text needs not to be performed in a case where the absolute value of the difference between the numbers of characters is equal to or smaller than the threshold value.

As a matter of course, the above-described example is a mere example, and a determination criterion may be appropriately changed. In one specific example, threshold values to be applied to determination as to whether the number of characters of a target text is larger than the number of characters displayable in a text region, and to determination as to whether the number of characters of a target text is smaller than the number of characters displayable in a text region may be individually set. A ratio between the number of characters of a target text and the number of characters displayable in a text region may be used as a value to be compared with a threshold value. As a matter of course, also in this case, threshold values to be applied to determination as to whether the ratio exceed a threshold value, and to determination as to whether the ratio is equal to or smaller than the threshold value may be individually set. In this manner, as long as whether the number of characters of text displayed in a text region is excessively larger than the number of characters displayable in the text region, or the number of characters of text displayed in a text region is excessively smaller than the number of characters displayable in the text region can be determined, a determination method is not specifically limited.

In step S2003, the text data processing necessity determination unit 402 confirms, with the user, whether to perform the processing on text displayed in the target text region.

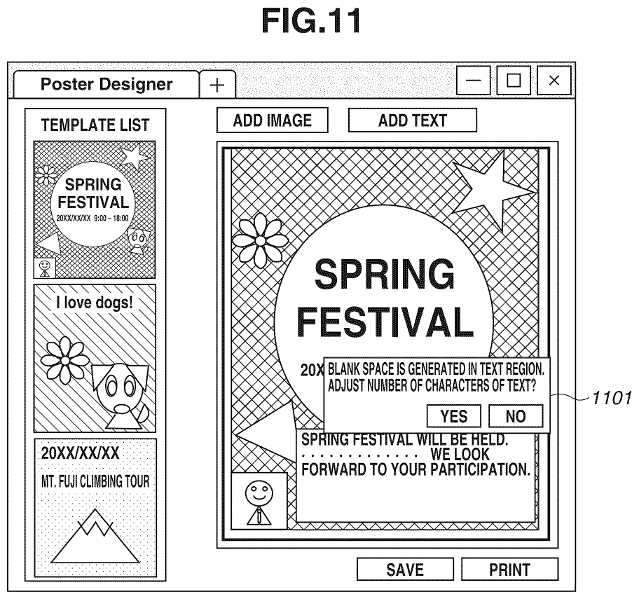

For example, FIG. 11 is a diagram illustrating an example of a state of the layout data edit screen 600, and illustrates an example of an input interface for receiving, from the user, an instruction to perform or not to perform the processing on text displayed in the target text region. Specifically, in the example illustrated in FIG. 11, a pop-up window 1101 is displayed, and an instruction to perform or not to perform the processing on the target text is received from the user via the pop-up window 1101.

For example, in a case where a “NO” button displayed on the pop-up window 1101 is pressed, the text data processing necessity determination unit 402 recognizes that an instruction not to perform the processing on the text displayed in the target text region has been received from the user. In a case where the text data processing necessity determination unit 402 determines in step S2003 that the instruction not to perform the processing on the text displayed in the target text region has been received from the user (NO in step S2003), the text data processing necessity determination unit 402 ends the series of processes illustrated in FIG. 8.

On the other hand, in a case where the “YES” button displayed on the pop-up window 1101 is pressed, the text data processing necessity determination unit 402 recognizes that an instruction to perform the processing on the text displayed in the target text region has been received from the user. In a case where the text data processing necessity determination unit 402 determines in step S2003 that the instruction to perform the processing on the text displayed in the target text region has been received from the user (YES in step S2003), the text data processing necessity determination unit 402 advances the processing to step S2004.

The processing related to receiving of the instruction from the user in step S2003 corresponds to an example of first reception processing.

In step S2004, the text replacement unit 403 requests the text processing unit 412 of the server 104 to perform the processing of text input into the target text region. In this example, the text replacement unit 403 requests the text processing unit 412 to perform processing for changing the number of characters without changing content of the text currently input into the target text region.

In step S2005, the prompt generation unit 413 generates a prompt for causing a language generation AI (the language generation unit 415 and the large-scale language model 416) to perform the processing requested by the client 102 in step S2004. For example, in a case where the number of characters of text displayable in a target text region is 400, and the number of characters of text displayed in the text region is smaller than 400, the prompt generation unit 413 generates a prompt exemplified below.

Increase the number of characters of the following text to 400 without changing the content.
A spring festival will be held.
We look forward to your participation.

An example of specific processing related to generation of a prompt will be described below. The prompt generated in step S2005 is output to the language generation unit 415.

In step S2006, using the large-scale language model 416, the language generation unit 415 performs the processing on the target text in accordance with an instruction described in the prompt generated in step S2005. The processing of text can be implemented by the language generation AI technique that uses an LLM such as ChatGPT® and Bard®, for example. In the present exemplary embodiment, the language generation AI to be used is not specifically limited as long as the language generation AI uses a large-scale language model. For example, in accordance with the prompt exemplified in the description of the processing in step S2005, the language generation unit 415 generates text with an increased number of characters while maintaining the content of the target text as indicated below.

A spring festival will be held. The weather is getting warmer by day.
How about joining us to deepen our friendship while enjoying cherry blossom viewing?
We look forward to your participation.

The text generated in step S2006 is transmitted by the text processing unit 412 to the text replacement unit 403 of the client 102.

In step S2007, the text replacement unit 403 replaces an original text in the layout data DB 400 with the processed text received from the server 104.

In step S2008, the text display update unit 404 updates display of the target text region in accordance with an update result of the layout data DB 400 that has been obtained in step S2007, and ends the series of processes illustrated in FIG. 8.

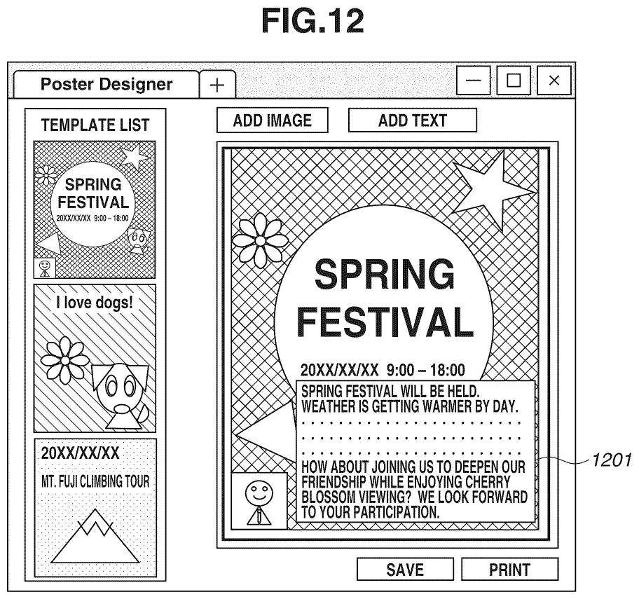

For example, FIG. 12 is a diagram illustrating an example of the layout data edit screen 600, and illustrates an example of a result of updating the display of the target text region by the series of processes illustrated in FIG. 8. A text region 1201 illustrated in FIG. 12 corresponds to the text region 1001 in the example illustrated in FIG. 10, and by the series of processes described with reference to FIG. 8. In the text region 1201, text with the number of characters adjusted in accordance with the size is displayed.

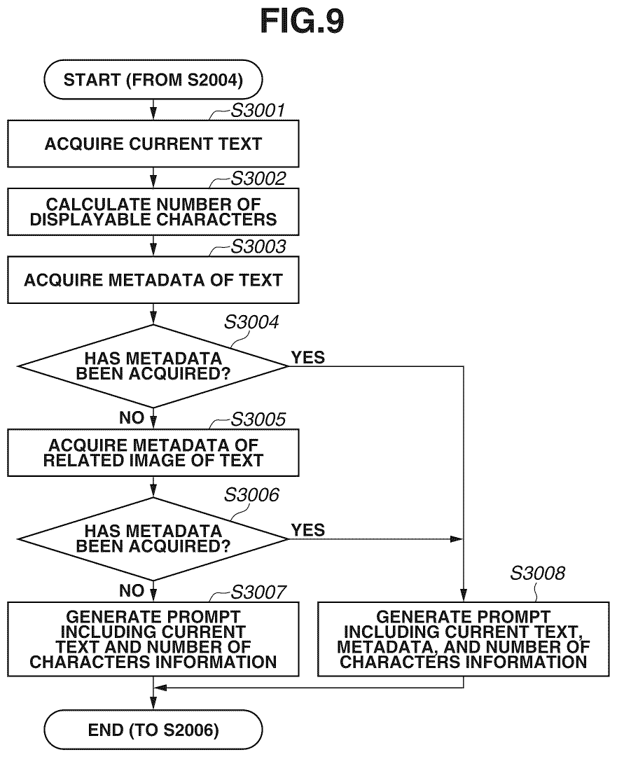

Subsequently, an example of prompt generation processing, described as the processing in step S2005 of FIG. 8, will be described in more detail with reference to FIG. 9.

In step S3001, the prompt generation unit 413 acquires text in the target text region that is stored in at least one of the layout data DBs 400 and 410.

In step S3002, the prompt generation unit 413 calculates the number of characters displayable in the current text region.

In step S3003, the metadata acquisition unit 414 acquires metadata of text of interest at the time (i.e., metadata set in the target text region).

In step S3004, the metadata acquisition unit 414 determines whether the metadata of the text of interest has been acquired in step S3003.

In a case where the metadata acquisition unit 414 determines in step S3004 that the metadata of the text of interest has been acquired (YES in step S3004), the metadata acquisition unit 414 advances the processing to step S3008.

On the other hand, in a case where the metadata acquisition unit 414 determines in step S3004 that the metadata of the text of interest has not been acquired (NO in step S3004), the metadata acquisition unit 414 advances the processing to step S3005. For example, in a case where no metadata is set to the text of interest (i.e., the target text region), the acquisition of the metadata from the text is not performed.

In step S3005, the metadata acquisition unit 414 acquires metadata of a related image of the text of interest (i.e., text in the target text region). Specifically, the metadata acquisition unit 414 acquires identification information set in metadata of a related image from among pieces of metadata for the target text region, and acquires metadata of an image to which the identification information is allocated.

In step S3006, the metadata acquisition unit 414 determines whether the metadata of the related image of the text of interest has been acquired in step S3005.

In a case where the metadata acquisition unit 414 determines, in step S3006, that the metadata of the related image of the text of interest has been acquired (YES in step S3006), the metadata acquisition unit 414 advances the processing to step S3008.

On the other hand, in a case where the metadata acquisition unit 414 determines, in step S3006, that the metadata of the related image of the text of interest has not been acquired (NO in step S3006), the metadata acquisition unit 414 advances the processing to step S3007. For example, in a case where no related image is set to the text of interest, or even if a related image is set, in a case where no metadata is set to the related image, the acquisition of the metadata of the related image of the text is not performed.

The processing in step S3007 is processing to be performed in a case where neither the metadata of the text of interest (i.e., the target text region) nor the metadata of the related image of the text has been acquired. In this case, the prompt generation unit 413 generates a prompt based on information regarding text in the target text region and the number of characters displayable in the text region. In this case, for example, a prompt indicated below is generated.

Increase the number of characters of the following text to 400 without changing the content.
A spring festival will be held.
We look forward to your participation.

The processing in step S3008 is processing to be performed in a case where at least one of the metadata of the text of interest (i.e., the target text region) and the metadata of the related image of the text has been acquired. In this case, the prompt generation unit 413 generates a prompt using information regarding the acquired metadata in addition to the information regarding text in the target text region and the number of characters displayable in the text region. In one specific example, in a case where information indicating “purpose: text inviting people to participate in the event” is set as the metadata of a text region, a prompt described below is generated.

The following text is a sentence that invites people to participate in the event. Increase the number of characters of the text to 400 without changing the content.
A spring festival will be held.
We look forward to your participation.

In both the case where the processing in step S3007 is performed and the case where the processing in step S3008 is performed, after a series of processes illustrated in FIG. 9 is performed, the processing transitions to the processing in step S2006 illustrated in FIG. 8.

As described above, in a case where the size, the font, and the interlinear size of a text region of a poster or a flyer is changed, the information processing system according to the present exemplary embodiment performs processing on a target text in accordance with the number of characters displayable in the text region, while maintaining the content.

By such control being applied, it is possible to display text maintaining the original content in a text region while the text is prevented from protruding from the text region, and an excessive blank space is prevented from being generated in the text region, for example. By such control being applied, it is also possible to prevent inconsistency with the entire design from occurring, unlike the case of preventing text protrusion and generation of an excessive blank space by adjusting a font size, for example.

In short, according to the present exemplary embodiment, even under a situation where the size of a text region can be changed, it is possible to adjust text to be displayed in the text region in a more desirable mode.

The configuration of the above-described information processing system according to the present exemplary embodiment is merely an example, and the configuration of the information processing system is not limited thereto as long as the processing described as the processing to be performed by the client 102 and the processing to be performed by the server 104 are substantially implemented. For example, allocation of the processing described as the processing to be performed by the client 102 and the processing to be performed by the server 104 may be appropriately changed. In one specific example, allocation of components (i.e., the allocation of processing) to the client 102 and the server 104 that has been described with reference to FIG. 4 may be appropriately changed.

The components of the client 102 and the server 104 may be provided in one information processing apparatus. Alternatively, at least some components of the components of the client 102 and the server 104 may be implemented by a network service such as a cloud service.

Modifications of the information processing system according to the first exemplary embodiment of the present disclosure will be described below as first to sixth modifications.

In the above-described first exemplary embodiment, an example of the case where the processing related to the processing of a target text is performed with a printing or saving operation serving as a trigger to start the processing has been described. On the other hand, by receiving an explicit instruction from the user, the processing of a target text may be started based on the instruction.

In one specific example, in a first modification, a button for receiving an instruction related to the processing of text from the user may be provided in the layout data edit screen 600, and in a case where the button is pressed, the processing of text in a text region that is selected as a target may be performed. In this case, because it is unnecessary to determine whether the processing of text is required, for example, control of omitting the determination processing in steps S2002 and S2003 in the series of processes illustrated in FIG. 8 and advancing the processing directly from step S2001 to step S2004 may be applied.

As a matter of course, the trigger to start the processing related to the processing of text is not limited to the explicit instruction received from the user, but may also be the printing or saving operation as in the first exemplary embodiment.

As described above, according to the first modification, it is possible to cause the information processing system to perform the processing related to the processing of a target text at a timing desired by the user.

In the above-described first exemplary embodiment, an example of the case where, in the prompt generation processing described with reference to FIG. 9, at least one of the metadata of text of interest (i.e., target text region) and the metadata of a related image of the text is used in generating a prompt has been described. On the other hand, it is possible to perform the processing on a target text without using metadata as in the processing in step S3007 where a prompt is generated without using metadata.

In one specific example, in a second modification, in a case where processing is performed on a target text in such a manner that the length thereof becomes shorter, because the processing is summarization processing, it is possible to perform the processing of a target text without using metadata. In another example, also in the case where the processing is performed on the target text in such a manner that the length thereof becomes longer, it is sometimes possible to perform the processing of the target text without metadata by using information regarding an original text.

In a case where nonuse of metadata in the processing of a target text is assumed in this manner, among the series of components illustrated in FIG. 4, the metadata acquisition unit 414 need not be provided. In addition, control of omitting the processing in steps S3003 to S3006 and S3008, among the series of processes illustrated in FIG. 9, and advancing the processing directly from step S3002 to step S3007 may be applied.

As described above, according to the second modification, because it is unnecessary to store metadata, an effect of reducing the capacity of a memory or a storage to be used can be expected in performing a series of processes related to the processing of a text.

In the above-described first exemplary embodiment, an example of the case where information regarding an original text, the number of characters, and metadata is used in generation of a prompt has been described. In a third modification, an example of a case where content indicated by an explicit instruction issued by the user, in addition to these pieces of information, are incorporated in generating a prompt will be described.

In one specific example, control may be applied to protect a part of a processing target text by receiving an instruction not to change the part of the text, from the user. In the above-described exemplary embodiment, by text displayed in the target text region being passed as a part of a prompt, the processing of the text is performed. At this time, although the content of the target text is maintained, wording of the text is not always maintained. On the other hand, a situation where the user wants to maintain the wording applied to at least a part of the target text can also be assumed.

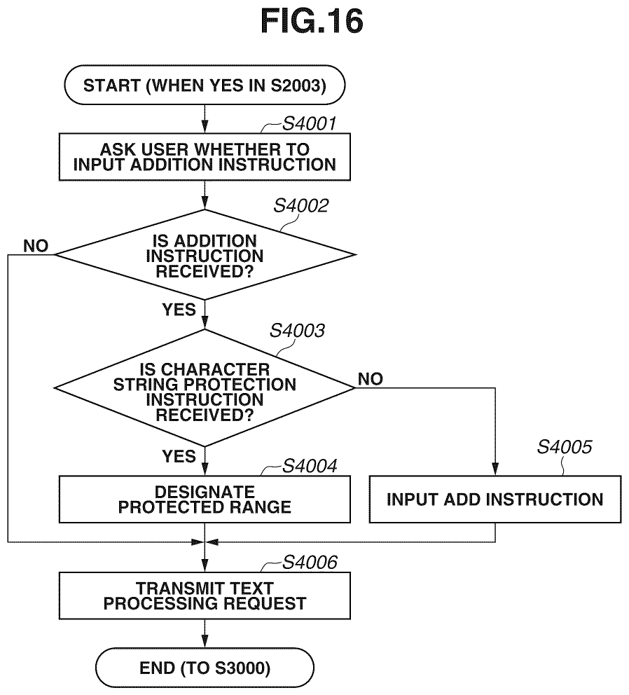

For example, FIG. 16 is a flowchart illustrating an example of the prompt generation processing, and illustrates another example of the processing in step S2004 illustrated in FIG. 8.

In step S4001, the prompt generation unit 413 asks the user whether to input an addition instruction related to the processing of a target text. The inquiry of the user whether to input an addition instruction can be made by, for example, displaying the inquiry on a window as a message, then displaying a button for selecting YES or NO, and receiving an instruction from the user via the button.

In step S4002, the prompt generation unit 413 determines whether an addition instruction from the user, i.e., an instruction related to addition of a condition for the text processing, has been received in step S4001.

In a case where the prompt generation unit 413 determines in step S4002 that an addition instruction from the user has been received (YES in step S4002), the prompt generation unit 413 advances the processing to step S4003.

On the other hand, in a case where the prompt generation unit 413 determines in step S4002 that an addition instruction from the user has not been received (NO in step S4002), the prompt generation unit 413 advances the processing to step S4006.

In step S4003, the prompt generation unit 413 determines whether the addition instruction received in step S4001 is a character string protection instruction.

In a case where the prompt generation unit 413 determines in step S4003 that the target addition instruction is a character string protection instruction (YES in step S4003), the prompt generation unit 413 advances the processing to step S4004.

On the other hand, in a case where the prompt generation unit 413 determines in step S4003 that the target addition instruction is not a character string protection instruction (NO in step S4003), the prompt generation unit 413 advances the processing to step S4005.

In step S4004, the prompt generation unit 413 receives, from the user, designation of a range of a character string that is included in a processing target text and is to be protected.

In step S4005, the prompt generation unit 413 receives the input of an addition instruction from the user. In one specific example, the prompt generation unit 413 may receive the input of an addition instruction from the user via the keyboard 308.

In step S4006, the text replacement unit 403 transmits text processing request to the server 104. At this time, in a case where an addition instruction has been received from the user in step S4004 or S4005, the text replacement unit 403 may include information indicating the addition instruction in the above-described text processing request.

The processing related to receiving of the addition instruction from the user, which has been described as the processing in steps S4001 to S4005, corresponds to an example of second reception processing.

After a series of processes illustrated in FIG. 16 is performed, the series of processes illustrated in FIG. 9 is continuously performed. Then, in a case where the addition instruction from the user has been received in the series of processes illustrated in FIG. 16, in step S3007 or S3008 illustrated in FIG. 9, generation of a prompt is performed in such a manner that content of the addition instruction is applied.

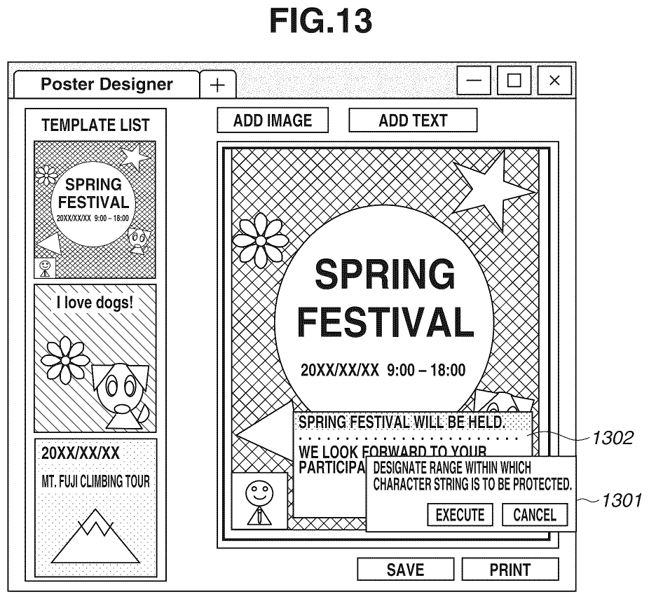

For example, FIG. 13 is a diagram illustrating an example of the layout data edit screen 600, and illustrates an example of a case where designation of a range of character string protection is received from the user. Specifically, in the example illustrated in FIG. 13, a pop-up window 1301 for receiving an instruction related to the designation of a range of character string protection from the user is displayed. Then, if an instruction from the user is received via the pop-up window 1301, the designation of a range of a character string that is to be protected and that is included in text displayed in a target text region is received from the user. By at least one character string in a target text being designated as described above, the character string is set as a target to be protected.

In the series of processes illustrated in FIG. 9, when a prompt is generated in step S3007 or S3008, an instruction indicating that “this part is not to be processed” is added to the prompt with regard to a preliminarily-designated character string. In this case, for example, a prompt described below is generated.

The following text is a sentence that invites people to participate in the event. Increase the number of characters of the text to 400 without changing the content. Nevertheless, do not modify the character string between ### and ***.
###
A spring festival will be held.
We look forward to your participation.

As described above, according to the third modification, when the processing of text is performed, it is possible to incorporate a demand from a user. In one specific example, by an instruction to hold at least one character string without a change being issued from the user in the processing of a text, it is possible to control the processing to be performed on a target text in a state in which the character string is maintained.

In the above-described first exemplary embodiment, an example of the case where, in the processing in step S2007 illustrated in FIG. 8, an original text is automatically replaced with a processed text has been described. In contrast, in a fourth modification, a processed text is presented to a user before replacement is performed, and an instruction related to the text replacement is received from the user, whereby an original text is replaced with the processed text based on the instruction. At this time, assuming a situation where the processed text differs from text intended by a user, an instruction to perform processing on the text again may be received from the user.

Generally, a language generation AI does not always output the same result even if the same prompt is input. For this reason, if the processing of text is performed again by the language generation unit 415, a result obtained by performing processing different from the previous processing on the target text is expected to be output. In view of the above-described property, by providing a plurality of language generation units 415, in performing the processing of text again, a language generation unit 415 different from the language generation unit 415 used in the previous processing may be caused to perform the processing of a text. In this case, the plurality of language generation units 415 may be provided in the same server, or may be individually provided in mutually-different servers.

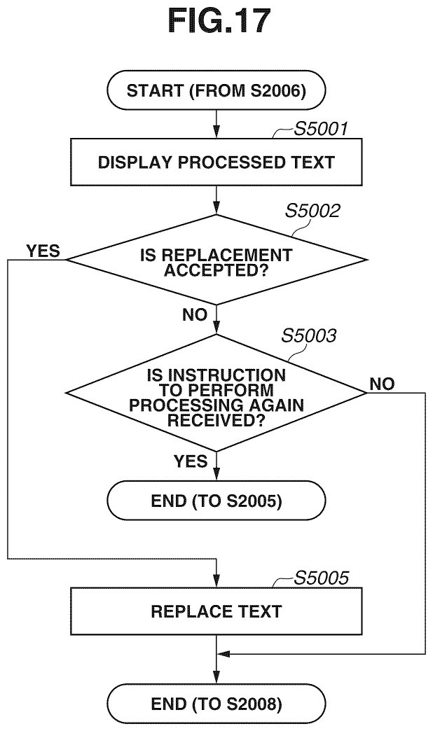

As an example of the processing to be performed by the information processing system according to the fourth modification, another example of the processing in step S2007 in FIG. 8 will be described with reference to FIG. 17.

In step S5001, the text replacement unit 403 displays a processed text in a predetermined display region. In step S5002, the text replacement unit 403 asks the user whether to accept replacement of an original text with the processed text. In one specific example, by displaying the processed text on a window, and displaying a button for selecting YES or NO on the window together with the processed text, the text replacement unit 403 may receive an instruction from the user via the window. Then, the text replacement unit 403 determines whether an acceptance of the text replacement is received from the user in response to the inquiry presented to the user in step S5002.

In a case where the text replacement unit 403 determines in step S5002 that the acceptance of the text replacement has been received from the user (YES in step S5002), the text replacement unit 403 advances the processing to step S5005. In step S5005, after the replacing an original text with a processed text, the text replacement unit 403 ends the series of processes illustrated in FIG. 17. Then, the text replacement unit 403 advances the processing to step S2008 of FIG. 8.

On the other hand, in a case where the text replacement unit 403 determines in step S5002 that the acceptance of the text replacement has not been received (has been refused) from the user (NO in step S5002), the text replacement unit 403 advances the processing to step S5003.

The processing related to receiving of the instruction to accept the text replacement from the user in step S5002 corresponds to an example of third reception processing.

In step S5003, the text replacement unit 403 asks the user whether to perform the processing of text again. In one specific example, by displaying a message for confirming whether to perform the processing of text again on a window, and displaying a button for selecting YES or NO on the window together with the message, the text replacement unit 403 may receive an instruction from the user via the window. Then, the text replacement unit 403 determines whether an instruction to perform the processing of text again has been received from the user.

In a case where the text replacement unit 403 determines in step S5003 that an instruction to perform the processing of text again is received (YES in step S5003), the text replacement unit 403 ends the series of processes illustrated in FIG. 17. Then, the text replacement unit 403 advances the processing to step S2005 of FIG. 8.

On the other hand, in a case where the text replacement unit 403 determines in step S5003 that an instruction to perform the processing of text again is not received (performing the processing again is refused) (NO in step S5003), the text replacement unit 403 ends the series of processes illustrated in FIG. 17. Then, the text replacement unit 403 advances the processing to step S2008 of FIG. 8.

The processing related to receiving of the instruction to perform the processing of text again from the user in step S5003 corresponds to an example of fourth reception processing.

By the above-described control being applied, when processing is performed on a target text, a result close to a result intended by the user can be obtained.

In the above-described first exemplary embodiment, an example of the case where the layout data is finally output to the image output apparatus, i.e., an example of the case where the information processing system according to the present exemplary embodiment is implemented as a printing system, has been described. On the other hand, a subject to which the technique according to the present exemplary embodiment is applied is not always limited only to the printing system. For example, also in a case where the layout data is edited assuming content to be mainly displayed via a display, the technique according to the present exemplary embodiment can be similarly applied. Specifically, also in the case where the content is displayed on the display, a situation where the number of characters that can be displayed in a text region and the number of characters that can be input into a text region are restricted in accordance with restriction on a display size and restriction on the system side can be expected. Under such circumstances, the technique according to the present disclosure may be applied.

Regarding a system configuration of an information processing system according to a fifth modification, in the system configuration exemplified in FIG. 1, the image output apparatuses 100 and 101 need not be provided. Regarding hardware configurations of the server 104 and the client 102, as in the first exemplary embodiment, the configuration illustrated in FIG. 3 can be applied. Regarding a functional configuration, among the series of components of the server 104 and the client 102 that are exemplified in FIG. 4, the print job transmission unit 405 and the printing image generation unit 418 need not be provided. Because the image output apparatus 100 need not be provided in the system configuration as described above with reference to FIG. 1, components corresponding to the image output apparatus 100 in the example illustrated in FIG. 4 needs not be provided.

As a matter of course, in the case of not only displaying the edited layout data but also enabling printing of the layout data, it goes without saying that such printing can be implemented by providing a component related to the printing of the layout data, as in the first exemplary embodiment.

As in the above-described first exemplary embodiment, the series of processes illustrated in FIGS. 8 and 9 can be applied to the processing to be performed by the information processing system according to the fifth modification.

As described above, regarding the information processing system according to the first exemplary embodiment of the present disclosure, also in a case where the layout data is edited assuming content to be mainly displayed via a display, it is possible to display text by an amount suitable for a text region.

In the above-described first exemplary embodiment, as illustrated in FIGS. 11 and 13, an example of the case where message display and menu selection are performed on a window is described as an example of a user interface (UI) that implements interaction between a system and a user. On the other hand, these UIs are mere examples, and are not always intended to limit the UI of the information processing system according to the first exemplary embodiment of the present disclosure. Thus, in a sixth modification, an example of a case where the interaction between the system and the user is dialogically implemented via a dialogue screen in a chat-like manner will be described. The system includes a dialogue learning model that dialogically makes a response to an instruction from the user and proposes processing to the user. The dialogue learning model may be implemented by the language generation unit 415 and the large-scale language model 416 or by another model.

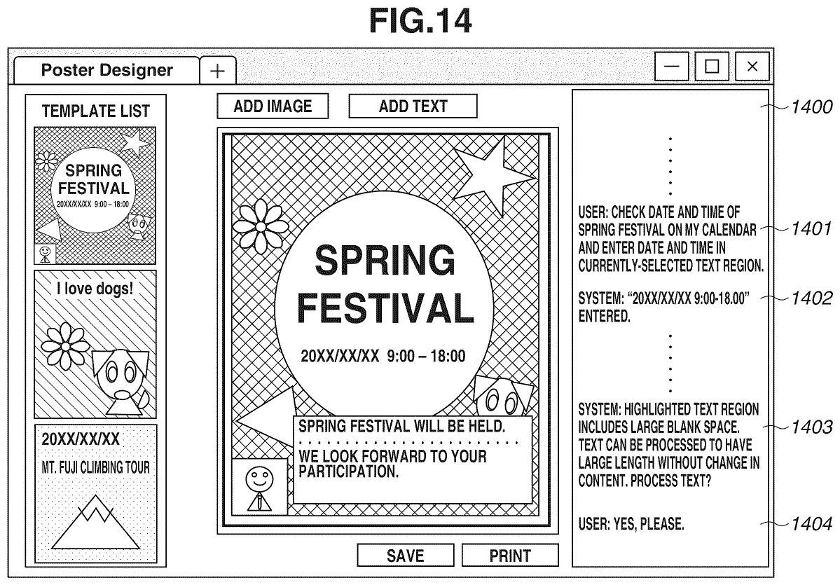

FIG. 14 is a diagram illustrating an example of a UI of an information processing system according to the sixth modification. A window 1400 is a window for realizing interaction between the system and the user, and content of a dialogue performed between the system and the user is displayed.

For example, output information 1401 and 1402 indicate examples of information indicating the interaction performed between the system and the user. The output information 1401 indicates the user's output information input by the user, and can be input via the keyboard 308, for example.

In the example illustrated in FIG. 14, by the output information 1401, an instruction to search for a date and time of SPRING FESTIVAL and enter the date and time in a text region is issued from the user to the system. The output information 1402 indicates content of a response from the system. In the example illustrated in FIG. 14, the response indicating that the date and time has been entered is made by the output information 1402. Through the interaction, text of the date and time is entered in a text region provided near the center of a layout editing area in FIG. 14.

Furthermore, in another text region provided in a lower part of the layout editing area in FIG. 14, text indicating “A spring festival will be held. We look forward to your participation.” is input. This text may be text (not illustrated) generated by dialogically issuing an instruction from the user and making a response from the system on the window 1400, or may be text directly entered by the user. Nevertheless, at this time, a large blank space remains in this text region. An example in which the system detects such a situation where the large blank space remains, and the system proposes processing of the input text will be described using output information 1403 and 1404. The output information 1403 indicates the proposal made by the system to the user. In the example illustrated in FIG. 14, by the output information 1403, the system proposes the processing of the text to the user since the large blank space remains in the text region. In response to this, in a case where the user accepts the proposal from the system, the user enters the acceptance on the window 1400. The output information 1404 indicates content of an instruction entered by the user in response to the proposal from the system. In the example illustrated in FIG. 14, by the output information 1404, the instruction to accept the proposal from the system is issued. When the system receives, from the user, the instruction to accept the proposal, the system performs the processing of the text by performing processing similar to the above-described processing in steps S2005 to S2006 of FIG. 8.

A method of receiving input from the user is not limited to the method that uses the keyboard 308, and various methods can be applied. In one specific example, the input from the user may be received using a technique such as voice input.

As a system configuration and a hardware configuration of the information processing system according to the sixth modification, configurations similar to those of the first exemplary embodiment can be applied.

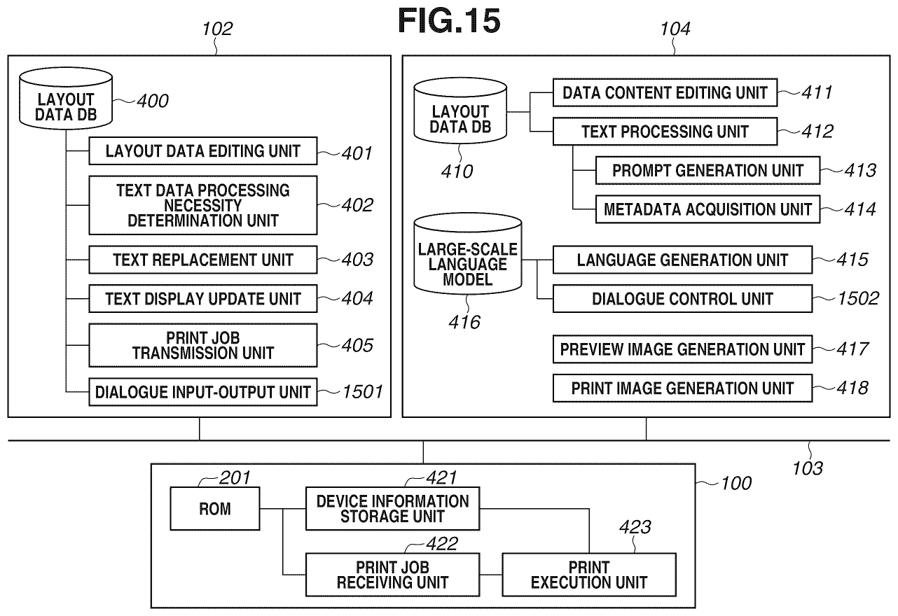

The functional configuration of the information processing system according to the sixth modification will be described below with reference to FIG. 15. In the sixth modification, the description will be given with a focus mainly on a part different from the first exemplary embodiment, and the detailed description of a part substantially identical to that in the first exemplary embodiment will be omitted.

A client 102 according to the sixth modification differs from that according to the example illustrated in FIG. 4 in that a dialogue input-output unit 1501 is provided. The dialogue input-output unit 1501 is a component of the client 102 that is provided to conduct a dialogue between the system and the user, and performs the reception of input form the user and the output of information to be presented to the user from the system.

A server 104 according to the sixth modification differs from that according to the example illustrated in FIG. 4 in that a dialogue control unit 1502 is provided. Using the language generation unit 415 that is based on the large-scale language model 416, the dialogue control unit 1502 performs various types of processing to conduct a dialogue between the system and the user. The dialogue control unit 1502 may also perform processing for solving an issue presented by the user, such an information search. The dialogue between the system and the user can also be conducted using a general language generation AI technique such as ChatGPT and Bard, for example. The technique to be used is not limited to the language generation AI technique, and another AI technique may be used.

The processing to be performed by the information processing system according to the sixth modification is substantially identical to that performed by the information processing system according to the above-described first exemplary embodiment, and thus the detailed description thereof will be omitted.

As described above, the information processing system according to the exemplary embodiment of the present disclosure can dialogically implement interaction between the system and the user when processing of text is performed to display the text in a text region so as to fit the size of the text region. By using such a UI, an effect of further improving usability of the system in editing layout data can be expected.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

In the above-described exemplary embodiment, a layout data creation application has been described as an example of an application, but the application is not limited to this example. The application can be any application having a similar image layout function, and such an application is effective.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-211949, filed Dec. 15, 2023, which is hereby incorporated by reference herein in its entirety.

What is claimed is:

1. An information processing apparatus comprising:
at least one memory that stores instructions; and
at least one processor that, upon execution of the stored instructions, is configured to:
calculate, based on a size attribute of a designated text region, a number of characters displayable in the text region;
generate a prompt including an instruction to perform processing on text, text that was input into the text region and the calculated number of characters; and
cause a learning model to generate processed text by performing the instruction included in the generated prompt on the text included in the generated prompt in accordance with the calculated number included in the generated prompt,
wherein the text input into the text region is updated with the generated processed text.

2. The information processing apparatus according to claim 1, wherein the processed text is generated by inputting the prompt to the learning model when a preset condition indicating a difference or a ratio between the number of characters of the text input into the text region and the calculated number of characters displayable in the text region and a preset threshold value, is satisfied.

3. The information processing apparatus according to claim 1,
wherein execution of the stored instructions further configures the at least one processor to receive an instruction to change a size of the designated text region from a user, and
wherein the processed text is generated by inputting the prompt to the learning model when the instruction for changing the size of the designated text region is received.

4. The information processing apparatus according to claim 1,
wherein the prompt is generated using at least one of metadata which have been set for the text region and metadata which have been set for content associated with the text region, and
wherein the generated prompt includes the instruction for causing the learning model to generate the processed text corresponding to the metadata.

5. The information processing apparatus according to claim 1,
wherein execution of the stored instructions further configures the at least one processor to receive an additional instruction including a condition regarding the processing to be performed on the text, and
wherein the prompt being generated is a prompt for issuing an instruction to cause the processed text satisfying the condition indicated by the received additional instruction to be generated.

6. The information processing apparatus according to claim 5,
wherein the received additional instruction includes an instruction to designate at least a partial range in the text input into the text region, and an instruction to restrict a change of the range, and
wherein the prompt being generated is a prompt described, based on the received additional instruction, such that a change of the range in the text input into the text region is restricted during generation of the processed text.

7. The information processing apparatus according to claim 1,
wherein execution of the stored instructions further configures the at least one processor to:
control the generated processed text to be displayed in a predetermined display region; and
update the text input into the text region with the processed text when an instruction to update the text input into the text region with the processed text is received.

8. The information processing apparatus according to claim 7,
wherein execution of the stored instructions further configures the at least one processor to receive an instruction to perform text processing again, and
wherein, when the text input into the text region is not updated with the processed text and the instruction to perform the text processing again is received, the processed text is generated again.

9. The information processing apparatus according to claim 1,
wherein execution of the stored instructions further configures the at least one processor to perform control of a dialogue learning model to generate a response to the instruction and to present the response dialogically to the user by inputting an instruction received from a user to a dialogue learning model trained to generate a response to an input instruction, and
wherein, in the control, the processed text is generated based on a first instruction received from the user, and the text input into the text region is updated with the processed text.

10. The information processing apparatus according to claim 9, wherein, in the control, text to be input into the text region is generated based on a second instruction received from the user.

11. A control method performed by an information processing apparatus, the control method comprising:
calculating, based on a size attribute of a designated text region, a number of characters displayable in the text region;
generating a prompt including an instruction to perform processing on text, text that was input into the text region and the calculated number of characters; and
causing a learning model to generate processed text by performing the instruction included in the generated prompt on the text included in the generated prompt in accordance with the calculated number included in the generated prompt,
wherein the text input into the text region is updated with the generated processed text.

12. A non-transitory computer-readable storage medium that stores instructions that cause at least one processor to:
calculate, based on a size attribute of a designated text region, a number of characters displayable in the text region;
generate a prompt including an instruction to perform processing on text, text that was input into the text region and the calculated number of characters; and
cause a learning model to generate processed text by performing the instruction included in the generated prompt on the text included in the generated prompt in accordance with the calculated number included in the generated prompt,
wherein the text input into the text region is updated with the generated processed text.
